(19) United States
(12) Patent Application Publication
(10) Pub. No.: US 2009/0300881 A1
(43) Pub. Date: Dec. 10, 2009

(54) Cam for a Hinge used in an Electronic Device

(76) Inventor: Chao-Chi Lin, Taichung (TW)

Correspondence Address: KAMRATH & ASSOCIATES, P.A., SUITE 245, 4825 OLSON MEMORIAL HWY., GOLDEN VALLEY, MN, 55422, US

(21) Appl. No.: 12/132,669

(22) Filed: Jun. 4, 2008

(51) Int. Cl. E05F 1/08

(52) U.S. Cl. 16/303

(57) ABSTRACT

A cam used in a hinge that is connected to an electronic device such as a notebook computer includes a first face and an axially spaced second face, a pivot hole axially extending through the first and second faces, the pivot hole comprised of a pair of substantially planar surfaces and a pair of substantially arcuate surfaces, and a block positioned at a corner defined between one planar surface and one arcuate surface. When a pintle of the hinge, which is used for pivotally connecting the electronic device and which includes a pair of planar surfaces and a pair of arcuate surfaces, is installed through the pivot hole of the cam, the first and second edges of each block are in contact with pintle and such that fit of the pintle in the pivot hole is tight at each corner.

### BACKGROUND OF THE INVENTION

1. Field of the Invention

The present invention relates to a hinge used in an electronic device such as a notebook computer a cam, in particular, the hinge has a cam that does not make undesired noise when the hinge is operated.

2. Description of the Related Art

Referring to Taiwan Pat No. M309841, a cam member 2 that makes lessened unusual noise includes a pivot hole 21 that allows a pintle A to be inserted through, the pivot hole 21 being comprised of a pair of arcuate walls that are opposed to each other and a pair of planar walls joining the pair of arcuate walls, and each arcuate wall has one protruded points 213 extended therefrom, or alternatively, each planar wall has two protruded points 213 extended therefrom. The pintle A includes a pair of arcuate walls and a pair of planar walls, the arcuate walls are point contacted by the arcuate walls of the pivot hole respectively when the pintle A is installed in the pivot hole, or alternatively, the planar walls are point contacted by the protruded points 213 at the same time.

Although the protruded points 213 reduce area of interference between the walls of the pivot hole 21 and the pintle A while making gap therebetween relatively small such that connection between the cam 2 and the pintle A is tight and as a result decreasing noise resulted from interaction of the pintle A and the cam 2, connection between the cam 2 and the pintle A as a matter of fact is not tight and improvements for reducing noise could be accomplished.

The present invention is, therefore, intended to obviate or at least alleviate the problems encountered in the prior art.

### SUMMARY OF THE INVENTION

According to the present invention there is provided, a cam used in a hinge that is connected to an electronic device such as a notebook computer includes a first face and an axially spaced second face, a pivot hole axially extending through the first and second faces, the pivot hole comprised of a pair of substantially planar surfaces and a pair of substantially arcuate surfaces, and a block positioned at a corner defined between one planar surface and one arcuate surface.

Preferably, there being four blocks included in four corners of the pivot hole, respectively.

Each block has an extent reaching the related planar and arcuate surfaces and includes a first edge elevated from the related planar surface and a second edge elevated from the related arcuate surface.

When a pintle of the hinge, which is used for pivotally connecting the electronic device and which includes a pair of planar surfaces and a pair of arcuate surfaces, is installed through the pivot hole of the cam, the first and second edges of each block are in contact with pintle and such that fit of the pintle in the pivot hole is tight at each corner.

Preferably, the pair of planar surfaces of the pintle are respectively engaged with the pair of planar surfaces of the cam and have a gap A defined in between, and the pair of arcuate surfaces of the pintle are respectively engaged with the pair arcuate surfaces of the cam and also have a gap A defined in between.

It is an object of the present invention that tight fit of the pintle and the pivot hole at corners precludes the cam from making undesired noise when the hinge is operated.

It is another object of the present invention that the gaps imply that the pivot hole could be made with greater marginal tolerance, thus resulting save for a manufacturing cost and increase of production speed and ease of installation on the pintle.

It is also noted that each block has a first end formed as a sloped edge to facilitate insertion of the pintle in the pivot hole.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

For the present disclosure to be easily understood and readily practiced, the present disclosure will now be described in conjunction with the following figures, wherein;

FIG. 1 is a perspective view of a cam for a hinge used in an electronic device in accordance with the present invention.

FIG. 2 is another perspective view of the cam of FIG. 1.

FIG. 3 is a side elevation view of the cam of FIG. 1.

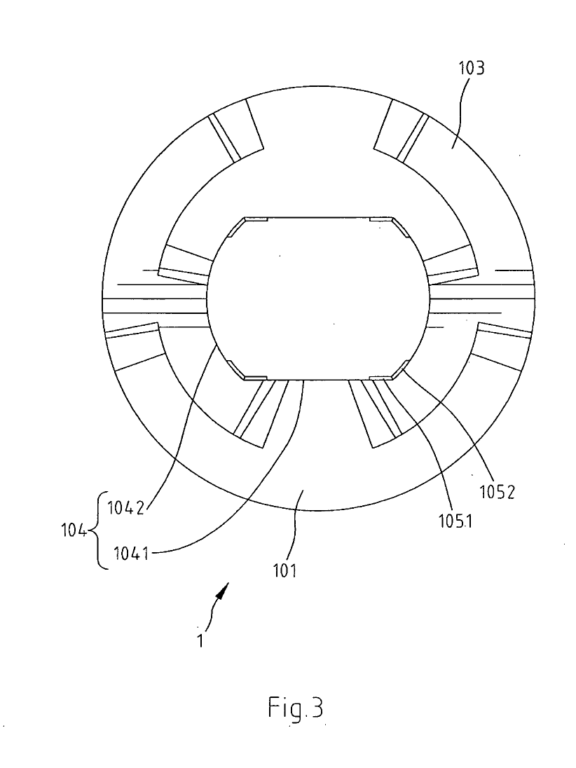

FIG. 4 is a cross-sectional view taken along line 4-4 of FIG. 1.

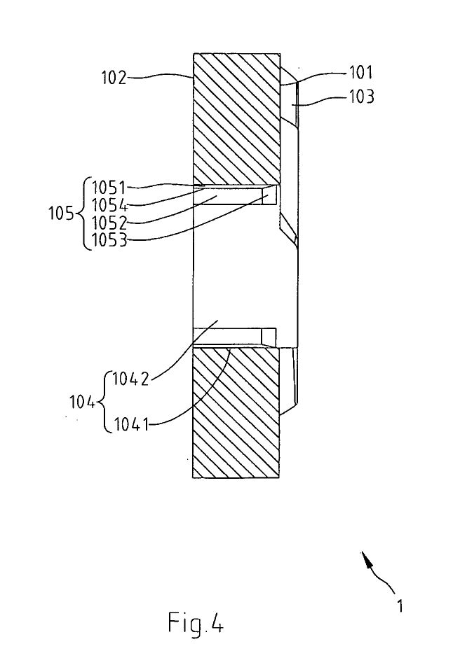

FIG. 5 is a perspective view showing the cam and a pintle of the hinge incorporated.

FIG. 6 is a cross-sectional view taken along line 6-6 of FIG. 5.

### DETAILED DESCRIPTION OF THE PREFERRED EMBODIMENT

Referring to the drawings, a cam 1 used in a hinge that is connected to an electronic device such as a notebook computer includes a first face 101 and an axially spaced second face 102, a ridge 103 on the first face 101, a pivot hole 104 axially extending through the first 101 and second 102 faces, the pivot hole 104 including a pair of substantially planar surfaces 1041 being opposed to each other and a pair of substantially arcuate surfaces 1042 being opposed to each other, and a block 105 positioned at a corner defined between one planar surface 1041 and one arcuate surface 1042. In this embodiment, there being four blocks 105 included in four corners of the pivot hole 104, respectively. Further the block 105 at each corner has an extent reaching the related planar 1041 and arcuate 1042 surfaces and includes a first edge 1051 elevated from the related planar surface 1041 and a second edge 1052 elevated from the related arcuate surface 1042. Additionally, the first edge 1051 is substantially parallel to the related planar surface 1041 and the second edge 1052 is substantially parallel to the related arcuate surface 1042.

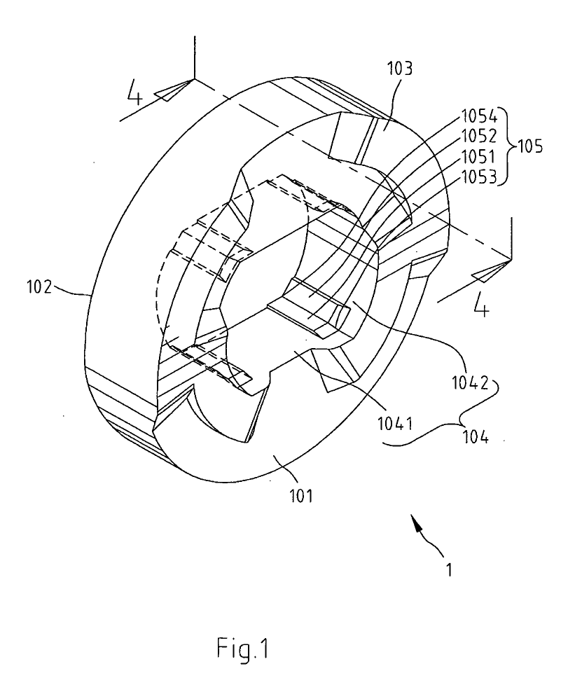

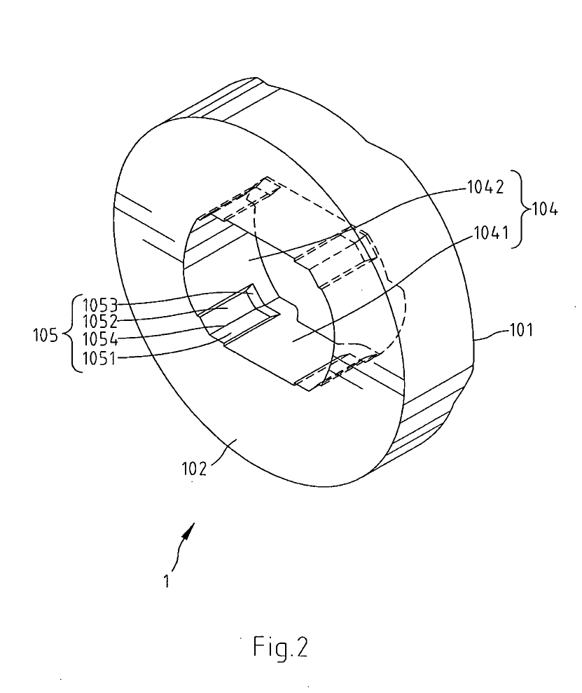

FIGS. 1 and 2 show that the block 105 at each corner includes a first end 1053 and an axially spaced second end 1054. The first end 1053 has an extent reaching the related planar 1041 and arcuate 1042 surfaces of the pivot hole 104 and is adjacent to the first face 101. The second end 1054 has an extent reaching the related planar 1041 and arcuate 1042 surfaces of the pivot hole 104 and is adjacent to the second face 102. Further, in FIGS. 1 and 2, it can be noted that the first end 1053 and the first face 101 has a distance apart while the second end 1054 is flush with the second face 102.

As also shown in FIGS. 1 and 2, the first end 1053 of each block 105 is formed as a sloped edge and a portion of the sloped edge that interconnects the first edge 1051 and the related planar surface 1041 cooperates with the planar surface 1041 to define an acute angle while another portion of the sloped edge that interconnects the second edge 1052 and the related arcuate surface 1042 cooperates with the arcuate surface 1042 to define an acute angle.

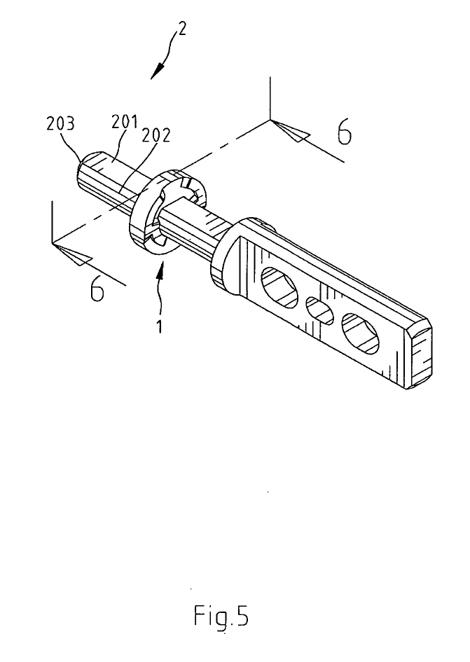

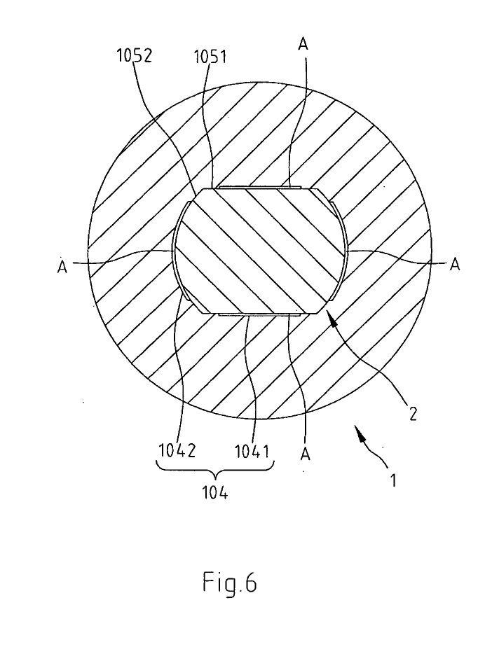

Referring to FIGS. 5 and 6, when a pintle 2 of the hinge, which is used for pivotally connecting the electronic device and which includes a pair of planar surfaces 201 and a pair of arcuate surfaces 202, is installed through the pivot hole 104 of the cam 1, the pair of planar surfaces 201 of the pintle 2 are respectively engaged with the pair of planar surfaces 1041 of the cam 1 and have a gap A defined in between, and the pair of arcuate surfaces 202 of the pintle 2 are respectively engaged with the pair arcuate surfaces 1042 of the cam 1 and have a gap A defined in between. Then each block 105 has a first edge 1051 in contact with a portion of the planar surface 201 of the pintle 2 that is adjacent to that block 105, and a second edge 1052 in contact with a portion of the arcuate surface 202 of the pintle 2 that is adjacent to that block 105. As such, corner defined between one planar surface 201 and one arcuate surface 202 of the pintle 2 is in tight fit with the related corner of the cam 1 and whereby the cam 1 does not make undesired noise when the hinge is operated. Further, the gaps A imply that the pivot hole 104 could be made with greater marginal tolerance, thus resulting save for a manufacturing cost and increase of production speed and ease of installation on the pintle 2.

It is also noted that the first end 1053 of each block 105 being formed as a sloped edge can facilitate an inerting end 203 of the pintle 2 in the pivot hole 104.

While the specific embodiments have been illustrated and described, numerous modifications come to mind without significantly departing from the spirit of invention and the scope of invention is only limited by the scope of accompanying claims.

What is claimed is:

1. A cam used in a hinge that is connected to an electronic device, with the hinge having a pintle, with the pintle pivotally connecting the electronic device, the cam comprising:
a first face and an axially spaced second face;
a pivot hole through which the pintle is adapted to be inserted being defined through the first and second faces, with the pivot hole including a pair of substantially planar surfaces being opposed to each other and a pair of substantially arcuate surfaces being opposed to each other; and
a block positioned at a corner defined between one planar surface and one arcuate surface in the pivot hole, the block having an extent reaching the planar and arcuate surfaces, the block further having a first edge elevated from the planar surface to contact with the pintle and a second edge elevated from the arcuate surface to contact with the pintle and such that fit of the pintle in the pivot hole is tight at the corner.

2. The cam as claimed in claim 1, with the pairs of planar and arcuate surfaces where the extent of the blocks are not reached and the pintle received in the pivot hole having gaps defined in between respectively.

3. The cam as claimed in claim 1 wherein the block at each corner of the pivot hole comprises a first end and an axially spaced second end, the first end has an extent reaching the related planar and arcuate surfaces of the pivot hole and is adjacent to the first face, the second end has an extent reaching the related planar and arcuate surfaces of the pivot hole and is adjacent to the second face, and the first end and the first face has a distance apart.

4. The cam as claimed in claim 3, with the first end of each block being a sloped edge, a portion of the sloped edge that interconnects the first edge and the related planar surface cooperates with the related planar surface to define an acute angle to thereby cause insertion of the pintle in the pivot hole to be facilitated, and another portion of the sloped edge that interconnects the second edge and the related arcuate surface to define an acute angle to thereby cause insertion of the pintle in the pivot hole to be facilitated.

5. The cam as claimed in claim 3 wherein the second end of each block is flush with the second face thereof.

6. The cam as claimed in claim I wherein the first edge is substantially parallel to the planar surface and the second edge is substantially parallel to the arcuate surface.
